(19) United States
(12) Patent Application Publication
(10) Pub. No.: US 2015/0315005 A1
(43) Pub. Date: Nov. 5, 2015

(54) Compact Apparatus for Preserving and Dispensing a Food Product, in Particular a Yogurt

(71) Applicants: COMPAGNIE GERVAIS DANONE, Paris (FR); ATENA SRL, Falciano (SM)

(72) Inventors: Federico CORBELLI, Domagnano (SM); Benoit LIENART, La Celle Saint Cloud (FR)

(21) Appl. No.: 14/649,483

(22) PCT Filed: Dec. 4, 2013
(86) PCT No.: PCT/EP2013/075460

§ 371 Date: Jun. 3, 2015

(30) Foreign Application Priority Data
Dec. 4, 2012 (FR) 12 61580

(51) Int. Cl. B67D 1/00; B67D 1/08; B67D 1/10

(52) U.S. Cl. CPC B67D 1/0007; B67D 1/108; B67D 1/0858

(57) ABSTRACT

The apparatus (1) for preserving and dispensing a food product such as a yogurt has a reservoir (4) outside which the product can be extracted by actuating an extraction device (20). The apparatus makes it possible to store and cool the reservoir in a storage compartment (3). The reservoir (4), in the form of a malleable packaging whereof the inner volume decreases in response to the extraction of the food product, is loaded in a holder (11) and fastened in a reclined position using fastening members (63, 64). In said reclined position, the opening of the reservoir faces a slit of the holder and the reservoir (4) extends between its rear end, which is kept in a stationary and adjacent position with respect to the rear end of the holder, and its front end, which is kept in a stationary and adjacent position with respect to the front end of the holder, independently of the deformation of the reservoir (4).

### TECHNICAL FIELD OF THE INVENTION

The present invention relates to an apparatus for preserving and dispensing, on demand, a liquid or pasty food product, typically a cold dairy product such as a yogurt composition, for example.

### BACKGROUND OF THE INVENTION

The use of malleable reservoirs to store a fluid product, from which a dispensing tube exits, is already known from document U.S. Pat. No. 7,651,010, for example. Dosing pumps cooperate with the dispensing tube. An extraction device is provided to cause the product to flow through said dispensing tube.

A dispensing device comprising this type of reservoir generally has a significant bulk, in particular heightwise. This represents a constraint for transporting the device and limits the possibilities for the usage location thereof. Furthermore, the device described in document U.S. Pat. No. 7,651,010 does not make it possible to ensure preservation of the product, such that it is not suitable for dispensing cold dairy products. Furthermore, dairy products have a higher viscosity than that of a liquid beverage. Due to the higher viscosity of a dairy product (a yogurt composition of the Activia® type typically being able to reach 1,100 mPa·s at a typical storage temperature of 5° C.), circulation in a circuit with several pumps may prove less effective. As a result, the user may not be sure of obtaining the desired dose of the product. This limits the scope of application of this type of device.

Furthermore, for applications with yogurt or similar cold products in particular, it is in practice considered necessary to throw away the entire circuit when the reservoir is changed. A drawback of the aforementioned device is that the consumable part (to be thrown away after use), which has several nozzles and hoses, is relatively complex, and therefore fairly expensive. This limits the commercial interest of this type of device.

There is therefore a need for systems for preserving and dispensing dairy products combining several of the following advantages:
effective preservation of the cold product;
reduction in the bulk of the device;
simplification of the consumable parts;
reduction in the number of steps necessary to change the reservoir (the system then being more attractive for the individual who must manage it).

### BRIEF DESCRIPTION OF THE INVENTION

The present invention aims to improve this situation by making the system more compact and attractive, and better suited to the preservation and dispensing of cold dairy products.

To that end, the apparatus for preserving and dispensing, on demand, a liquid or pasty food product includes:
a storage compartment;
a food product reservoir comprising an opening, the reservoir having a length defining a larger dimension of the reservoir, the reservoir extending lengthwise between a rear end and a front end near which the opening is positioned;
a dispensing line connected to the reservoir at the opening to channel the food product;
a holder for mounting the reservoir inside the storage compartment; and
an extraction device for the food product channeled in the dispensing line;
a cooling device suitable for refrigerating the food product contained in the reservoir when the reservoir is in the storage compartment;
   wherein the reservoir is a malleable packaging such as a flexible pouch, the inner volume of which decreases in response to the extraction of the food product outside the reservoir,
   and wherein the holder has a rear end, a front end and an upper opening extending between the front end and the rear end of the holder, the holder further comprising:
a slit formed on the side of the front end and passed through by the dispensing line in a loaded configuration of the holder; and
at least one first fastening member to keep, in the loaded configuration of the holder, the rear end of the reservoir in a stationary and adjacent position with respect to the rear end of the holder; and
at least one second fastening member to keep, in the loaded configuration of the holder, the front end of the reservoir in a stationary and adjacent position with respect to the front end of the holder.

With such arrangement, the reservoir can extend in a reclined position with a primarily horizontal component that minimizes the bulk heightwise, with the additional advantage that the deformation and reduction of the inner volume of the reservoir may be controlled so as to avoid the formation of creases detrimental to the effectiveness of the extraction, in particular when the residual quantity of food product of the yogurt or similar type represents approximately 20% or less of the initial volume of the reservoir.

The effectiveness and uniformity of the cooling may be improved due to the better sizing of the storage compartment, and it is possible to place a pump of the extraction device as close as possible to the opening of the reservoir, typically overhanging said opening. The length of the dispensing line may thus be reduced to the smallest length necessary.

The use of such a holder facilitates the installation operations with correct positioning of the reservoir and removal of the consumable assembly that is formed by the reservoir and the dispensing line. The slit, which cooperates with the dispensing line, makes it possible to place the reservoir in the right direction with a guiding effect for the fastening position.

According to one particularity, the fastening members are arranged to attach the reservoir to the holder removably, the holder including two panels and a bottom wall connecting the two panels, each of the panels comprising:
one of the first fastening members adjacent to the rear end of the holder; and
one of the second fastening members adjacent to the front end of the holder.
   With this arrangement, the operator can perform the fastening on the sides of the holder simply, which is easier than an intervention from below (with the understanding that the reservoir for example weighs 5 kg).

In various embodiments of the apparatus according to the invention, it is optionally furthermore possible to use any of the following provisions:
the rear end of the holder extends at an upper position (raised rear end) with respect to the front end when the holder is in the loaded configuration inside the storage compartment, the bottom wall extending inclined downwardly from the raised rear end of the holder as far as the front end of the holder (the incline thus favors the flow of the food product toward the opening situated toward the front, the inclined reclined position which is neither horizontal nor vertical corresponding to an advantageous compromise to obtain better compactness of the apparatus, allow effective distribution with uniform cooling);
the reservoir is made by assembling two sheets made from a flexible material each having an oblong shape and welded to each other by a peripheral weld seam, the reservoir having a height defining a smaller dimension of the reservoir and measured transversely with respect to the peripheral weld seam (this format facilitates complete emptying of the reservoir, with an effect gradually bringing the sheets closer to each other as the reservoir empties, without forming creases owing to the fastening members that maintain a stretched configuration of the reservoir lengthwise);
the peripheral weld seam has four sides coming together forming two rear corners on the side of the rear end of the reservoir and two front corners on the side of the front end of the reservoir, the front corners each protruding outward and being engaged with the first fastening members and the rear corners each protruding outward and being engaged with the second fastening members (this arrangement makes it possible to perform remote fastening of the food product, in light of the oblong shape of the two sheets making up the reservoir);
the dispensing line extends continuously downward from a first height level defined by the opening of the reservoir as far as an outlet, the second fastening members being configured at a same second height level that coincides with said first height level, whereby this opening can be kept at the first height level despite the decrease in the inner volume of the reservoir during food product extraction operations (this arrangement thus makes the height reduction of the reservoir during its use compatible with the maintenance in position of the dispensing line that is used by the extraction device and that must preferably be kept in a cooling area adjacent to the storage compartment);
the first fastening members comprise two first slits distributed in each of the two panels and elongated in a first direction, while the second fastening members comprise two second slits distributed in each of the two panels and elongated in a second direction, the first direction being different from the second direction, with the understanding that when the holder is in a configuration loaded inside the storage compartment, the first direction may be horizontal and the second slits may extend to a level lower than the level of the first slits (this arrangement is compatible with the use of a slope to support the reservoir, so as to benefit from the gravitational force during dispensing);
the extraction device comprises a peristaltic pump that can cooperate with a flexible hose of the dispensing line and configured to circulate the food product toward an outlet in response to a command to dispense a dose of food product;
the reservoir and the pump are arranged in a same enclosure including the storage compartment and refrigerated by the cooling device, the storage compartment being deeper than it is tall.

It should be mentioned that in the present application, a viscous or pasty food product refers to a product having a high viscosity, typically greater than 50 mPa·s, preferably greater than 300 mPa·s, and preferably lower than 2,000 mPa·s, preferably lower than 1,500 mPa·s. The viscosity may in particular be comprised between 600 mPa·s and 1,500 mPa·s. In the present application, unless otherwise stated, the indicated viscosities are viscosities measured at 10° C., with a shearing of 64 s⁻¹, after a time of 10 s at that shearing, using a rheometer with two coaxial cylinders, for example using a Mettler® RM 180 or 200 rheometer.

The food product is preferably a cold food product, for example fermented milk, for example yogurt. It is preferably a mixed fermented milk, for example a mixed yogurt.

### BRIEF DESCRIPTION OF THE DRAWINGS

Other features and advantages of the invention will appear during the following description of several embodiments, provided as non-limiting examples, in light of the attached drawings, in which:

FIG. 1 is a diagrammatic view showing the elements of a dispensing circuit of an apparatus according to one preferred embodiment of the invention;

FIGS. 2A and 2B respectively illustrate the closed configuration and the open configuration of the casing of a pump that can be used in the apparatus according to the invention;

FIGS. 3A and 3B are front views showing an apparatus with the door open, respectively before and after installation of the pump;

FIG. 4A shows a dispensing line closed by a stopper;

FIG. 4B shows the assembly formed by the reservoir and the dispensing line before use in an apparatus according to the invention;

FIG. 5 is a front view of an appliance for preserving and dispensing food products such as yogurt, in the operating state;

FIG. 6 is a perspective view showing the rear of an apparatus according to the invention;

FIG. 7 is a diagram illustrating steps that may be carried out upon removing the assembly formed by the reservoir and the dispensing line;

FIG. 8 illustrates an example of the connection of the shaft of a pump according to one embodiment according to the invention;

FIGS. 9A and 9B are respectively side and top diagrammatic views of a holder loaded with the reservoir, according to one embodiment of the invention.

### DETAILED DESCRIPTION OF THE INVENTION

In the different figures, identical references indicate identical or similar elements.

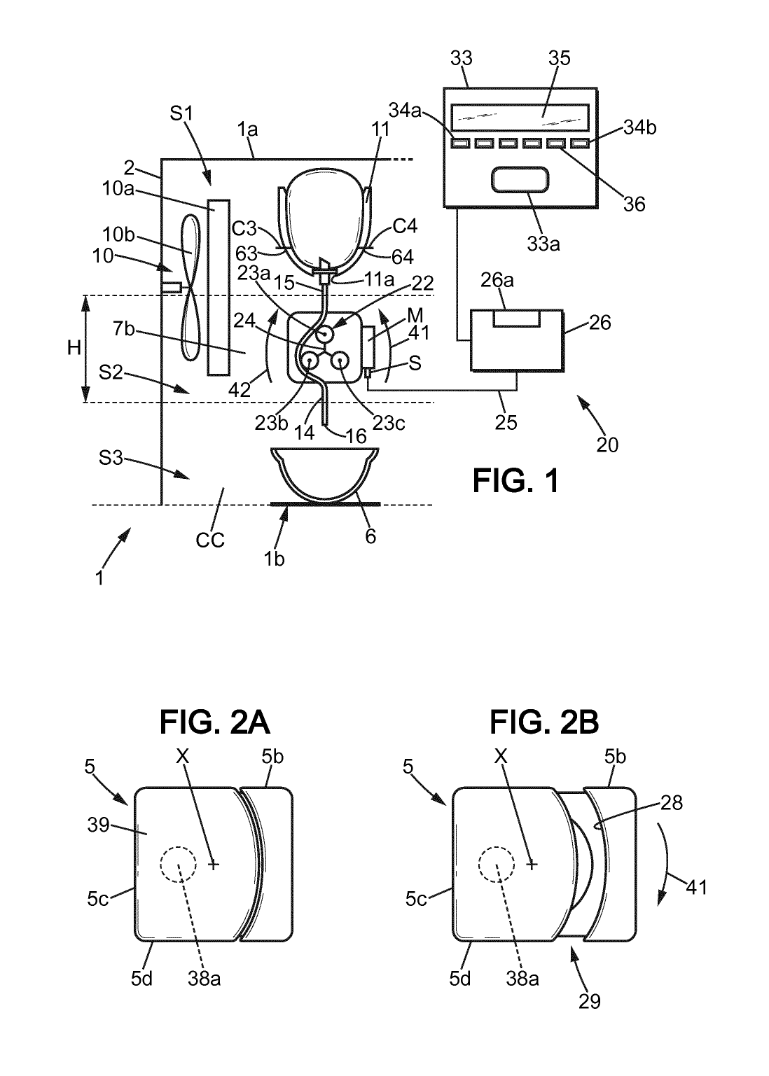

In reference to FIG. 1, the apparatus 1 has a chassis 2 that can be divided, at least for the purposes of the description, into several sections, respectively an upper section S1 in which a storage compartment 3 is provided for a food product reservoir 4, an intermediate section S2 in which a pump 5 can be mounted, and a lower section S3 having a collection compartment CC where the food product can be collected, for example using a suitable container such as a bowl or cup 6. The upper S1 and intermediate S2 sections contain an enclosure 7, thermally isolated to delimit a cooling area.

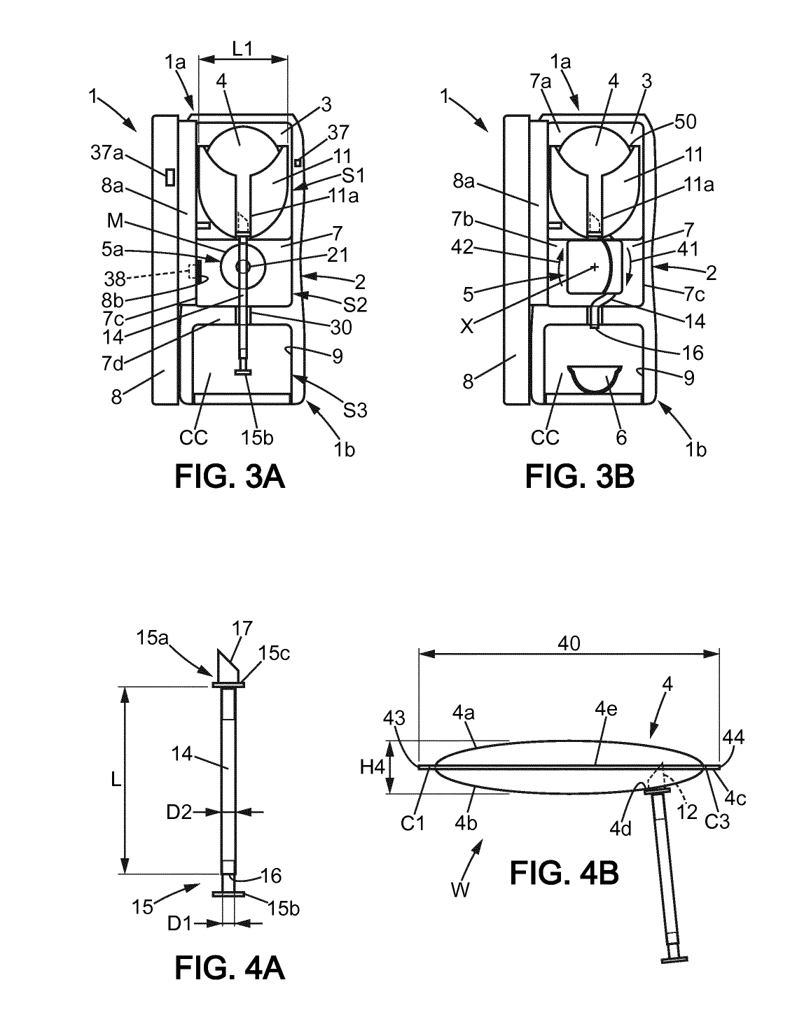

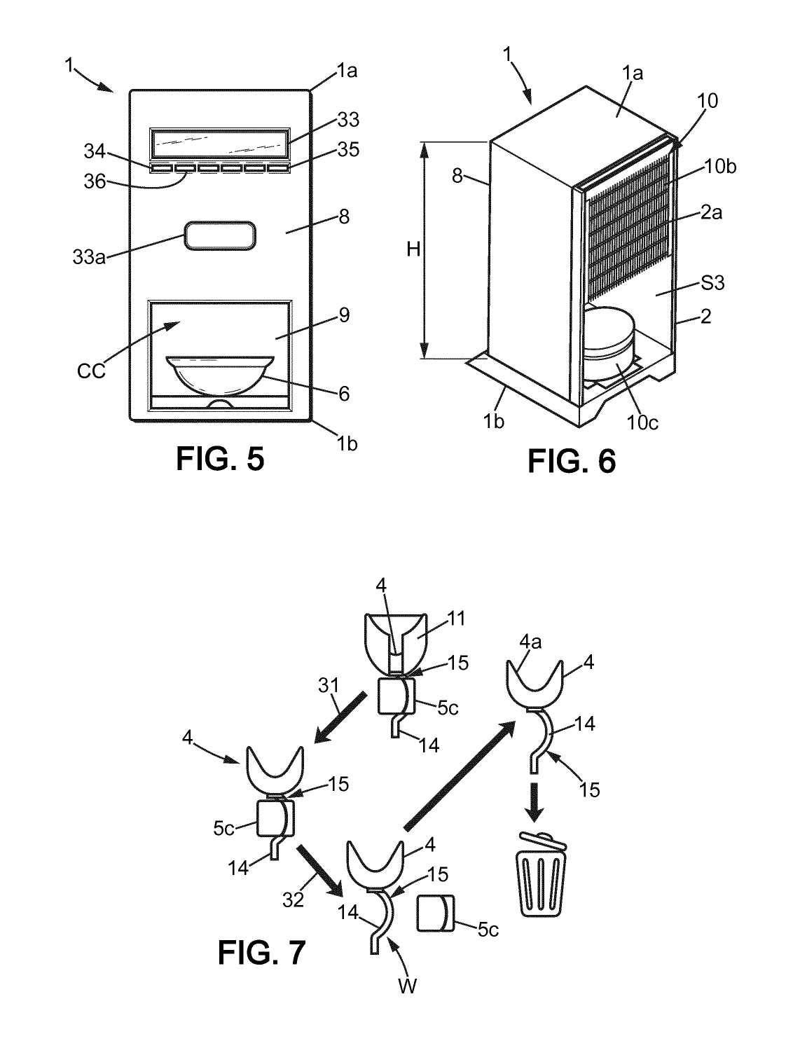

As shown in particular in FIG. 3B, the storage member 3 corresponds to or extends in a subpart 7a of the enclosure 7 that here is situated on the side of the upper end 1a of the apparatus 1 and superimposed on another subpart 7b of the enclosure 7 where the pump 5 is housed. The subpart 7b is preferably shallower than the subpart 7a. Housing the pump 5 under the storage compartment 3 makes it possible to limit the dimensions of the storage compartment 3, while the loading and unloading operations of the reservoir 4 may be facilitated as will be described later.

As shown in FIGS. 3A and 3B, the side walls of the chassis 2 and a folding door 8 arranged in the front of the chassis 2 delimit the enclosure 7, which emerges to the outside through an opening 7c allowing frontal access. When the apparatus 1 is used, this opening 7c is covered by the door 8, which comprises at least one isolating panel 8a. This opening 7c here provides frontal access for being situated on the same side as the access to the collection compartment CC. Under the enclosure 7, an opening 9 is also provided, preferably on the same side as the opening 7c for access to the enclosure 7, but not limited thereto. This opening 9, which is close to the lower end 1b of the apparatus 1, is not covered by the door 8 or then only partially, such that the collection compartment CC remains freely accessible after closing of the door 8.

A cooling interface of a cooling device 10, for example in the form of an evaporator exchanger 10a of a refrigerating facility, is arranged in the enclosure 7, preferably in a peripheral area of the storage compartment 3. A fan 10b of the cooling device 10 can be provided in the enclosure 7 so as to homogenize the temperature, in particular in the storage compartment 3. In reference to FIGS. 1 and 6, the cooling device 10 may be of a type known in itself and configured using a thermostat so that the temperature (which must remain above 0° C.) inside the storage compartment is comprised between 1 and 7° C., and preferably between 2 and 4° C. A refrigerating installation for example provided with a condenser 10b, a compressor 10c, an expander and the evaporator exchanger 10a is preferred, in particular when the ambient temperature may exceed 35° C. In order to minimize the outer volume of the apparatus 1 and in particular to reduce the height H, the chassis 2, which here is parallelepiped, may integrate the compressor 10c into its inner volume at the lower section S3, as illustrated in FIG. 6. In this way, the height of the upper section S1 may be reduced and the storage compartment 3 may extend as far as the rear wall 2a of the chassis 2 to have a depth substantially corresponding to the largest dimension or length 40 of the reservoir 4, visible in FIG. 4B.

In order to preserve the food product, facilitate dispensing by pumping, and simplify the replacement operations for the apparatus 1 with food product, the reservoir 4 here assumes the form of a malleable packaging such as a flexible pouch. The shape and inner volume of the flexible pouch change under the effect of the action of the pump 5, such that the extraction of the food product outside the reservoir 4 is made easier.

In one preferred embodiment and as shown in FIG. 4B in particular, the reservoir 4 may be made by assembling two sheets 4a, 4b of flexible material (for example, a plastic or multi-layer material), each having an oblong shape with dimensions that here are identical. The sheets 4a, 4b are welded to each other by a peripheral weld seam 4c. A quick connector 12 having an inner part and optionally an outer part is provided in one of the two sheets 4b. This quick connector 12 defines a single opening 4d of the reservoir 4. The single opening 4d is placed near a small side of the reservoir 4. This positioning may make it possible to facilitate emptying of the reservoir 4 when the latter is kept on a holder 11 with a slope or other means for raising the rear end 43 of the reservoir 4 opposite the single opening 4d. The quick connector 12 is for example made from rigid plastic. The oblong shape of the sheets 4a, 4b is preferred here because it makes it possible to obtain an overall shape that is very different from the cylindrical shape that is not advantageous for the effectiveness of the extraction in the reservoir 4 (in particular when the residual volume of food product is small). The welding in a median plane of the reservoir 4 further makes it possible to minimize the effects of folding, which create dead spaces.

More generally, it will be understood that the reservoir 4 may have any configuration suitable for forming a flexible pouch. The plastic material used makes it possible to reduce the outer volume of that pouch when the food product is consumed and is suitable for contact with food. Of course, the reservoir 4 is airtight and it is preferable to use a single connecting member such as the quick connector 12 indicated above or another comparable sealing connector. In a horizontal position of the reservoir 4 as illustrated in FIG. 4B, the reservoir 4 has a height H4 that may correspond to its smallest dimension, that dimension being measured transversely with respect to the peripheral weld seam 4c.

In reference to FIGS. 1, 3A and 3B, the reservoir 4 here is mounted on a holder 11 that has an opening or a slit 11a. This holder 11 is placed in the storage compartment 3 and may be fastened removably. Preferably, the holder 11 slides horizontally in that storage compartment 3. The slit 11a extends vertically up to a bottom point of the holder 11, on the side of the opening 6. Owing to this slit 11a, the opening 4d may be oriented downward while being placed in a position adjacent to the intermediate section S2. Thus, the dispensing line 15 may have previously been connected to the reservoir 4 at the opening 4d, then be positioned through the slit 11a at the time of installation of the reservoir 4 in the storage compartment 3, while extending descending between its upper end for connecting to the reservoir 4 and its lower end at which an outlet 16 is provided. The sizing of the storage compartment 3 and the arrangement of the holder 11 for example allow the reservoir 4 to occupy approximately 90% of the inner volume of the storage compartment 3. In one alternative embodiment, walls of the storage compartment 3, for example provided with shoulders and optionally with a slit for guiding the dispensing line 15, may make it possible to directly support the reservoir 4 (which makes it possible to avoid the use of a removable holder).

In reference to FIGS. 4A and 4B, one can see that the dispensing line 15 may comprise only:
a flexible hose 14, which preferably has a length L comprised between 12 and 50 cm, and preferably comprised between 18 and 35 cm; and
a connecting member 15a, preferably a male member allowing a safe and quick connection by engagement with the quick connector 12 of the reservoir 4, after piercing the sheet 4b at the opening 4d.

The protective nozzle 15b shown in FIGS. 3A, 4A and 4B is optional and may be removed and thrown away before the first dispensing operation of the food product. Hereafter, the dispensing line 15 encompasses only the flexible hose 14 and the associated connecting member 15a, fastened by insertion into the flexible hose 14 at the upper end thereof. The length L of the flexible hose 14 is greater than the height H2 of the subpart 7b where the pump 5 is housed without exceeding twice that height H2. The insertion of the connecting member 15a into the opening 4d of the sheet 4b may be done while keeping the reservoir 4 with the sheet 4a in contact against a flat holder and pushing the tip 17 into the reservoir 4. The tip 17 is short enough with respect to the head of the reservoir 4 and the weld seam 4c prevents any risk of piercing the opposite sheet 4a. It will be understood that this configuration of the reservoir 4 is therefore practical and effective for an operator needing to install the assembly formed by the reservoir 4 and the dispensing line. Furthermore, the quick connector 12 of the reservoir may have means for rotational blocking (for example, by using a polygonal shape) and retention of the connection member 15a when the flange 15c is in contact with the sheet 4b, which prevents accidental removal of the connecting member 15a.

The small length L of the flexible hose 14 makes it possible to minimize the consumable material. In fact, after having been emptied, or when a usage expiration date has been exceeded (in particular when the food product is a yogurt composition or similar dairy product), it is necessary to change the reservoir 4 and the dispensing line 15. Furthermore, a direct descending path is obtained (without rising) when the food product is conveyed between the opening 4d of the reservoir 4 and the outlet 16.

The device 20 for extracting the food product will now be described in reference to FIGS. 1, 2A-2B and 3A-3B.

In the apparatus 1 diagrammatically illustrated in FIG. 1, the extraction device 20 is connected to the flexible hose 14 so as to circulate the food product channeled in the dispensing line 15 toward the outlet 16. The extraction device 20 comprises the pump 5, which is of the peristaltic type. Hereafter, the term peristaltic will be understood in its broadest interpretation, with the understanding that this term designates any pumping member using mechanical pressure on the outside of the flexible hose 14.

In this non-limiting example, the pump 5 is made up of a frame 5a, visible in FIG. 3A, on which a motor M, here electric, is fastened, whereof the shaft 21 rotates a cage hereafter called a rotor 22 including a plurality of rollers 23a, 23b, 23c. FIG. 1 shows that in the pump 5, the flexible hose 14 is simply bowed (a single curve extending between an upper end away from the reservoir 4 and the lower end away from the outlet 16). The pressing rollers 23a, 23b, 23c push on the interface of the bowed portion. These rollers 23a, 23b, 23c are typically mounted freely rotating at the end of radial arms 24 and come together at the shaft 21 defining the axis of rotation X. These radial arms 24 are secured to said shaft 21, which is rotatably connected to the electric motor M. This motor M here is equipped with a sensor S that counts the number of rotational revolutions of the shaft 21 and uses an electrical circuit 25 to send that information to the control unit 26.

In the flexible hose 14 engaged in the pump 5, the inner space for the food product between two of the rollers 23a, 23b, 23c may correspond to a volume of approximately 1 mL. For a rotor 22 with three rollers 23a, 23b, 23c, it will thus be understood that a little more than 3 mm can be evacuated during a complete revolution of the rotor 22. Of course, a rotor 22 comprising another number of rollers (for example greater than or equal to four) may be used.

The flexible hose 14 may be made from a shape memory material such as silicones or a flexible material having similar properties (in particular elastic deformation, crushing resistance), that material being suitable for being in contact with food. In reference to FIG. 4A, the flexible hose 14 for example has an outer diameter D2 at least equal to 10 mm and preferably about 12 mm, knowing that the inner diameter D1 of that hose 14 is preferably greater than 5-6 mm, and for example approximately 7 mm. It will be understood that the thickness of the wall of the hose 14 may be chosen between 2 and 3 mm, for example 2.5 mm.

With this type of hose 14 and this type of food product (for example, a mixed fermented milk composition with a viscosity of about 1,100 mPa·s), the pump 5 can operate with a speed of rotation of 300 rpm (i.e., 5 rps). One may thus conclude, if 1 mL is contained in the space between two of the rollers 23a, 23b, 23c, a little more than 15 mL of food product may be recovered each second during extraction. A dose of about 90-100 mL of food product may therefore be recovered in only 6 seconds.

Referring to FIGS. 1 and 2A-2B, the pump 5 includes a stator portion 5b arranged on the periphery of the rotor 22. The stator portion 5b is part of the casing 5c, which further includes a complementary fastening portion 5d that is connected to the frame 5a and surrounds the rotor 22. The stator portion 5a forms at least one reaction surface 28 engaged with the flexible hose 14 of the dispensing line 15 in a pumping configuration in which the flexible hose 14 is locally crushed between at least one of the rollers 23a, 23b, 23c of the rotor 22 and the reaction surface 28. During the operation of the pump 5, it will be understood that the rollers 23a, 23b, 23c are in contact with the flexible line 14, which they deform and crush until sealing occurs. The angular movement of the sealing point causes, behind the crushed area, an underpressure in the hose 14, which immediately fills with fluid food product. The quantity of food product captured in the hose 14 between two of the rollers 23a, 23b, 23c is then pulsed toward a discharge side of the pump 5. In the casing 5c of the pump 5, a cylindrical inner face, called a step, is provided, against which the flexible hose is crushed by the rollers 23a, 23b, 23c to guarantee sealing of the hose. The reaction surface 28 is part of that step. An opening angle of at least 120° is provided here for the reaction surface 28 such that at any time, at least one of the three rollers 23a, 23b, 23c is across from that reaction surface 28, the hose being crushed at least at one point.

As appears in FIG. 2B, the pump 5 comprises an insertion channel 29 that passes through the casing 5c to receive the flexible hose 14. The stator portion 5b is movable, for example by sliding, between an access position to the insertion channel 29 in which the stator portion 5b is separated from the axis of rotation X, and a closed position of the insertion channel 29 in which the stator portion 5b is close to the axis of rotation X.

The casing 5c of the pump 5 may have a fastening connector on the shaft 21 of the motor that enables easy removal of the removable part of the casing-rotor 5c, 22 of the pump 5 through the opening 7c of the enclosure 7. To that end, the motor M may have a shaft 21 extending in a direction that passes through the opening 7c. The fastening connector (not shown) is part of the fastening portion 5d and may be arranged across from the access face to the insertion channel 29, i.e., on the rear face of the casing 5c. In the state mounted on the frame 5a of the pump 5, at least the casing-rotor assembly 5c, 22 (i.e., the pump head) extends entirely inside the enclosure 7.

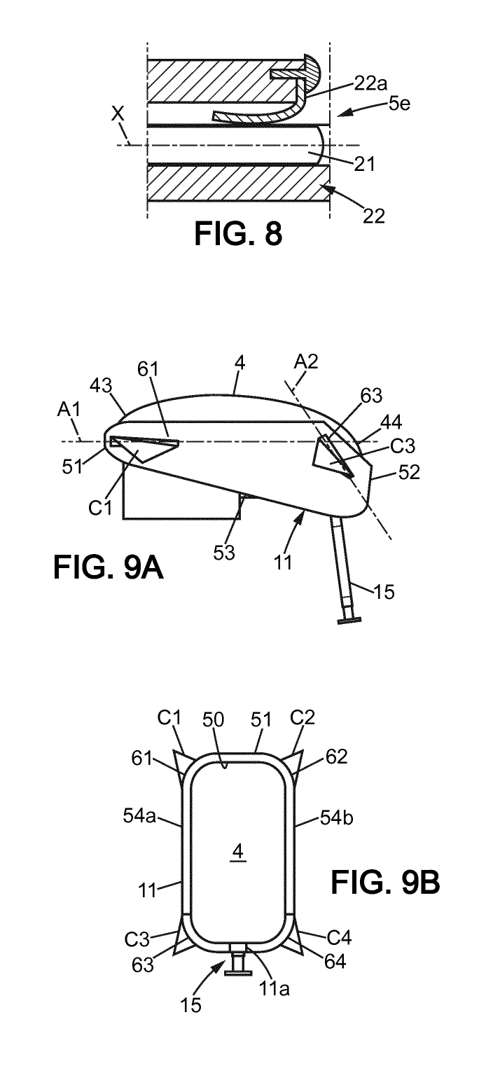

FIG. 8 shows one example of a quick connector for mounting on the shaft 21. The casing-rotor assembly 5c, 22 here is optionally removably mounted on the shaft 21 driving the pump 5 using elastic return means 22a and/or snapping members arranged inside a central orifice 5e (passing through the complementary fastening portion 5d and the rotor 22). Non-limitingly, elastic return means 22a may be provided oriented in a general direction parallel to the shaft 21. More specifically, these means may consist of a leaf spring that is positioned in the orifice 5e of the pump head in which the shaft 21 is inserted. It will be understood that the leaf spring exerts uniform pressure parallel to the longitudinal axis of the shaft 21. The shape of the leaf spring and its orientation parallel to the shaft 21 facilitate sliding (guide function) along the shaft 21 during removal of the casing-rotor assembly 5c, 22. Independently of or in combination with the preceding, the shaft 21 may for example have a flat or another mistake-proofing member to enable correct positioning of the insertion channel 29 (to ensure that the first direction of rotation cannot be confused with the second direction due to poor positioning).

More generally, it will be understood that the connection can assume any form (for example with shape matching between the shaft 21 and an engagement portion of the rotor 22) making it possible to remove, if applicable to clean, and to easily reposition the casing-rotor assembly 5c, 22 on the shaft 21 multiple times, without affecting the precision of the flow rate of food product of the peristaltic pump 5. The casing 5c extends near the opening 7c, recognizing that this arrangement at the front of the subsection S2 of the chassis 2 makes it possible to free space to position at least part of the cooling device 10 on the side of the rear wall 2a of the chassis 2.

As illustrated in FIGS. 3A and 3B, a passage 30 formed in the lower wall 7d of the enclosure 7 emerges in the collection compartment CC. This passage 30 may thus be passed through by one end of the flexible hose 14 protrudes downward with respect to the lower wall 7d. One can see in FIG. 3A that the assembly W (consumable of FIG. 4B) composed of the reservoir 4, the dispensing line 15 and the optional associated stopper 15b may be installed in the apparatus 1 basically loading the reservoir 4 in the holder 11. In one preferred embodiment, the holder 11 forms a removable tray or basket, such that the loading in the holder 11 may be done outside the storage compartment 3. In this case, the placement is facilitated, as it suffices for the operator to insert the loaded holder 11 into the storage compartment 3. The width L1 of the holder 11 is slightly smaller than the width of the storage compartment 3 (for example, with lateral play of less than 2 cm), which makes it possible, during the insertion of the loaded holder 11 to position the slit 11a substantially overhanging the passage 30. The slit 11a, in which the dispensing line 15 is inserted, then makes it possible to guide the positioning of the reservoir 4 in the holder 11 before that insertion on the one hand, and to preserve a globally vertical arrangement of the dispensing line 15 after that insertion (and before placement of the removable part 5c, 22 of the pump 5) on the other hand.

The removable part 5c, 22 (without the motor M and without the frame 5a) of the pump 5 is mounted in the subpart 7b of the enclosure 7 and is configured in the access position to the insertion channel 29 as illustrated in FIG. 2B. The flexible hose 14 of the dispensing line 15 in its configuration illustrated in FIG. 3A is placed in the insertion channel 29. Before moving the stator portion 5b into the closed position, the operator ensures that the connecting member 15a of the dispensing line 15 extends completely outside the casing 15 (while avoiding any pinching). After closing, the outlet 16 is flush with or protrudes a short distance with respect to the outlet of the passage 30 into the collection compartment CC. The optional stopper 15b may be removed and thrown away only when this raised position of the outlet 16 is obtained (i.e., after fastening of the flexible hose 14 inside the casing 5c).

It will be understood that the operation for loading the reservoir 4 associated with the dispensing line 15 may be done quickly, which is advantageous to respect the cold chain. Of course, the door 8 may be closed during the operation for connecting the dispensing line 15 and the operation for loading the reservoir 4 in the holder 11.

In reference to FIG. 7, it is possible to see the steps making it possible to remove the consumable assembly W formed by the reservoir 4 and the dispensing line 15, in particular with separation for reuse of the holder 11 in step 31 and the removable part 5c, 22 of the pump 5 in step 32. It will be understood that only the rotational driving element (21, M) forms a stationary part of the arrangement allowing circulation of the food product. In this circulation arrangement, the detachable part of the pump 5 and the consumable assembly W are easily separated (as shown in FIG. 7) away from the chassis 2 of the apparatus 1.

In reference to FIG. 1, the rotational driving element (21, M), which in particular comprises the electric motor M, is configured here to rotate the rotor 22 of the pump 5 around the axis of rotation X in a first direction corresponding to a descending circulation of the food product toward the outlet 16 (direction of the arrow 41) and in a second direction (direction of the arrow 42) corresponding to an ascending circulation of the food product. The first direction as illustrated in FIG. 1 is reversed in the following FIGS. 2A to 3B, with the understanding that the pump 5 may indifferently have an insertion channel 29 placed on either side. To perform the distribution function of the apparatus 1, the rotational driving element (21, M) operates at a predetermined speed for each of the directions, that speed being able to be the same in the first direction and the second direction.

The extraction device 20 illustrated in FIG. 1 also includes means for controlling the dispensing of the food product. The electrical power supply of the extraction device 20, of the autonomous type or connected to a current distribution grid, is of a type known in itself and will not be outlined here. The control unit 26 has at least one management module 26a for the pump 5 suitable for receiving user commands coming from a user interface 33 connected to the control unit 26. A primary button 33a and a plurality of other buttons or keys 34a, 34b, 36 may be provided in said user interface 33, which furthermore comprises a display screen 35. At least one of the keys may be provided to display a programming menu that for example makes it possible to parameterize the viscosity of the food product. With a predetermined speed of rotation of the rotor 22, this viscosity entered by the user may be taken into account by the control unit 26 to adjust the number of revolutions to be performed during a command for a dose, that number being able to be increased for a high viscosity and reduced for a low viscosity.

The management module 26a has a routine for determining a usage duration of the assembly formed by the reservoir 4 and the dispensing line 15, for example obtained by taking into account an event representing a beginning of use (for example, actuating an initialization procedure at the user interface 33 that is necessary upon the very first use of the new reservoir 4 and/or information that a threshold has been reached in the storage compartment 3 and/or a signal triggered by a detector upon insertion of the holder 11 into the compartment 3). As a non-limiting example, pressing two keys 34, 35 of the user interface 33 may serve to initiate the initialization procedure of the new reservoir 4.

The management module 26 may also in particular receive one or more of the following pieces of information:
information representative of temperature measurements in the enclosure 7, in particular in the storage compartment 3 of the subpart 7b where the pump 5 is housed;
information representative of measurements of a filling state of the reservoir 4;
information representative of a number of rotational revolutions of the shaft 21 of the motor M, counted by the sensor S.

This information may be displayed on the display screen 35, as well as information representative of having exceeded a threshold relative to the usage duration of the reservoir 4 and dispensing line 15 assembly. The control unit 26 and the interface 33 may have components of a type known in itself that will not be outlined here.

The management of the motor M during commissioning of the apparatus 1 will now be described in reference to FIGS. 1 and 3B.

The electric motor M with two directions of rotation may initially be actuated in the first direction corresponding to the arrow 41, for example when the user presses on two keys 34, 35 simultaneously, typically in response to an invitation shown on the display screen 35. Optionally, during this initialization, the motor M rotates the rotor 22 by a predetermined number of revolutions in the first direction (direction of the arrow 41) so that the food product flows in the flexible hose 14 of the dispensing line 15. In one preferred embodiment, this actuating accounts for the fact that the flexible hose 16 extends both in the enclosure 7, which is refrigerated, and in the passage 30 with, furthermore, an end portion that can protrude in the collection compartment CC as far as the outlet 16. More specifically, the pump 5 is commanded by the control unit 26 so as always to store the food product above the passage 30, i.e., completely in the inner volume of the enclosure 7. To that end, the management module 26a generates a rotation command corresponding to a necessary number of revolutions and sufficient to obtain that limited movement of the food product.

In order to store the food product present in the flexible hose 14 completely above the passage 30, it is provided, in response to a command to extract the food product that may be initiated by the primary button 33a or by a specialized key 36:
to remove the food product from the reservoir 4 by rotating the rotor 22 of the pump 5 in the first direction, such that a dose corresponding to the command may be recovered below the outlet 16; and
when said dose has been removed from the dispensing line 15 (i.e., when the number of revolutions necessary to extract the doses been reached), to move the food product remaining in the flexible hose 14 away from the outlet 16, by rotating the rotor in the second direction (direction of the arrow 42).

Preferably, the rotation of the rotor 22 in the second direction is commanded selectively by the management module 26a so that the rotational movement is always the same, for example one or two revolutions or even less than one revolution. The driving of the pump 5 in the opposite direction according to the arrow 42 thus makes it possible to raise the food product away from the outlet 16, such that the food product present in the dispensing line 15 is stored in or at least near the refrigerated storage compartment 3 (in the subpart 7b of the enclosure 7). In order to avoid any air rising up inside the reservoir 4, the control unit 26 can issue a predetermined food command such that the rotation in the second direction does not exceed one or two complete revolution(s) of the rotor 22. It is advantageous to provide a length L of the flexible hose 14 adjusted to the configuration of the apparatus 1 so as not to protrude too much in the collection compartment CC, for example with a distance smaller than 2 cm. Thus, the time necessary to raise the food product is very short and can be much shorter than one second. During this short time interval, the control unit 26 selectively commands the power supply of the electric motor, driving the rotation of the rotor 22 in the second direction (direction of the arrow 42), then commands the stop of the electricity supply to that motor M. This direction reversal is transparent to the eyes of the user who ordered the dose.

In one embodiment, when the user activates the extraction using the pushbutton 33a, the control unit 26 sends a command to rotate the rotor 22 of the pump 5 by a predetermined number of revolutions in the first direction, for example 30 revolutions, so as to deliver a predefined dose of food product (for example, about 90 or 100 mL).

Alternatively, the command may be done in a customized mode in which the filling duration of the cup 6 is determined directly by the user. In that case, the duration of pressing on a specialized key 36 may be taken into account and/or the release of the pushbutton 33a (or similar actuator) is interpreted by the control unit 26 as an end-of-extraction request. A contactor associated with the specialized key 36 or the pushbutton 33a may make it possible to initiate the power supply of the electric motor M in a manner known in itself. During the on-demand filling, the sensor S counts the number of revolutions performed by the rotor 22, and that number is stored in a memory at the disposal of the control unit 26. A calculation routine of the management module 26a makes it possible to convert the number of revolutions into a quantity of food product that is typically expressed in milliliters (or optionally in grams) and the display screen 35 then makes it possible to display the quantity resulting from that conversion.

Preferably, the filling duration may not exceed a predetermined threshold corresponding to a maximum authorized quantity, which is for example a function of the capacity of the cup 6 or other container provided to collect the food product. It will be understood that, irrespective of the quantity of extracted food product, the same type of cycle is performed with a rotation phase of several revolutions of the rotor 22 in the first direction immediately followed by a predetermined rotation phase not greater than one or two revolutions in the second direction.

In one embodiment, the extracted food product flow rate, analyzed in the number of revolutions of the rotor 22 (in particular using the sensor S), may be counted decreased by a predetermined number of revolutions that corresponds to what is necessary for the entire content of the reservoir 4 to flow. Typically, the content of the reservoir 4 before use is constant and about 1-7 kg, for example 5 kg. A remaining value representative of the quantity of product still available may be read on the display screen 35 and/or an indicator signaling a need to renew the food product may be displayed when the control unit 26 determines that the quantity of product still available is below a predetermined threshold.

The control unit 26 may also be configured to block a food product extraction command entered using the user interface 33 in response to detection of the noncompliant state of the apparatus 1. Such a noncompliant state may be detected when the temperature in the storage compartment 3 and/or in the subpart 7b of the enclosure 7 is outside an operating range, or when the usage duration of the product from opening of the reservoir 4 has been exceeded.

Optionally, it may be provided to detect a closing state of the door 8. The control unit 26 for example receives a signal corresponding to closing of the door 8 sent by a door sensor 37, 37a. The detection of the opening of the door 8 may be magnetic, the door sensor 37, 37a in that case having a magnetic member 37a secured to the door 8 and a detector device 37 secured to the rest of the chassis 2, as shown in FIG. 3A. When the control unit 26 receives the signal representative of the closing of the door, it authorizes the dispensing and a corresponding display mode may be activated at the display screen 35. It will be understood that such a door sensor 37, 37a facilitates verification by an operator that the enclosure 7 is indeed isolated.

Additionally or alternatively to the door sensor 37, 37a, a pump sensor 38, 38a may be provided to detect an operational configuration of the pump 5. As illustrated in FIGS. 2A-2B, the removable pump head formed by the casing-rotor assembly 5c, 22 for example has a magnetic member 38a, here onboard in the casing 5c, which can be detected by a probe 38 mounted in the door 8. When the pump is engaged on the drive shaft 21, in the manner illustrated in FIG. 8 or more generally by cooperation between matching shapes (typically male/female) between the shaft 21 and the corresponding engagement part of the rotor 22, maintenance in the blocked position may be obtained using the door 8. In this preferred but non-limiting embodiment, the door 8 has a surface 8b (visible in FIG. 3A) for engagement contact against the outer face 39 of the pump 5. The surface 8b may be defined over a local inner projection of the door 8. The bearing of the surface 8b toward the inside, with pressure on the surface 39 when the door 8 is in its closed state, makes it possible to lock the fastening configuration of the rotor 22. In other words, a relative movement of the rotor 22 (typically by sliding) with respect to the drive shaft 21 of the motor M is no longer possible after that locking. Thus, the pump 5 is correctly positioned.

Optionally, the control unit 26 can receive, from the probe 38, a signal corresponding to a detection of the magnetic member 38a. If, the magnetic member 38a is detected, the control unit 26 interprets the signal as closure of the door 8 and/or as a ready-to-operate state of the pump 5. If the magnetic member 38a is not detected, the control unit 26 interprets that as a disconnection of the pump 5. In the ready-to-operate state, the control unit 26 selectively puts the extraction device 20 in an operational state for which dispensing of the food product is accessible. A corresponding display mode may be activated at the display screen 35. In the opposite case, the control unit 26 blocks all or some of the command functions or activates an alert signaling that the placement of the pump 5 is not complete.

It will be understood that the sensors 37-37a and/or 38-38a may be of the nonmagnetic type, for example with detection of mechanical engagement in the closed state of the door 8. Furthermore, the probe 38 of the pump sensor 38, 38a may also be placed in a part of the apparatus 1 separate from the door 8, for example in a maintaining or fastening arm of the pump 5.

Embodiments of the mounting of the reservoir 4 in the holder 11 will now be described in reference to FIGS. 3A-3B, 4B, 7 and 9A-9B.

As illustrated in FIG. 9A, the holder 11 for example has a rear end 51, a front end 52 and a bottom wall 53 whereof the length may be identical to the length 40 of the reservoir 4. The rear 51 and front 52 ends are each formed by a wall element that extends upward from the bottom wall 53. The holder also includes left and right panels 54a, 54b, respectively, which extend between the rear end 51 and the front end 52. The width L1 of the holder 11 makes it possible to receive the reservoir 4 between the panels 54a and 54b, in an adjusted manner or with slight play when the reservoir 4 is not empty. However, protruding side portions for example from the corners C1, C2, C3, C4 of the reservoir 4 define a surplus with the reservoir 4. The upper face of the holder 11 defines an upper opening 50 that extends between the front end 51 and the rear end 52.

One can see that the bottom wall 53 is inclined descending downward and toward the front end 52, so as to facilitate the flow of the food product with a single outlet 4d. The incline may be continuous or discontinuous and the incline angle of the bottom wall 53 with respect to the horizontal does not exceed 40 or 45° (angle for example comprised between 10 and 30°). As an example, the rear end 51 is raised with respect to the front end 52. The wall element at the front end 52 preferably defines the vertical slit 11a and/or the slit 11a extends as far as the bottom wall 53 near the front end 52, at a level (lower point of the holder 11) situated completely below the rear end 43 of the reservoir 4 in the loaded configuration. FIG. 9A shows this loaded configuration. The incline may be zero on the side of the rear end 51, so as to reduce the bulk heightwise.

The holder 11 is thus generally in the shape of a basket with a support slope of the reservoir 4 and is easily inserted and removed in the storage compartment 3 when the door 8 is in the open position. In the non-limiting example of FIGS. 9A and 9B, the reservoir 4 is in the form of a flexible pouch with rear corners C1, C2 and front corners C3, C4 each protruding outward. These corners C1, C2, C3, C4 can for example be part of the peripheral weld seam 4c visible in FIG. 4B. It will be understood that the corners C1, C2, C3, C4 are each spaced apart in pairs and for example separated by a rectilinear portion 4e (visible in FIG. 4B) of the weld seam 4c. The panels 54a, 54b are respectively split near the rear end 51 and near the front end 52, so as to form removable fastening members for the reservoir 4. More specifically, the removable fastening members are distributed between rear fastening members comprising rear slits 61, 62 and front fastening members comprising front slits 63, 64. These slits 61, 62, 63, 64 make it possible to insert the front and rear corners C1, C2, C3, C4 through the panels 54a, 54b. The corners C1, C2, C3, C4 are then respectively engaged in the slits 61, 62, 63, 64 and ensure maintenance of the reservoir 4 in a lying down position in which the opening 4d faces the slit 11a (the opening 4d then being situated at equal distances from the two panels 54a, 54b). It will be understood that the rear end 43 of the reservoir 4 is blocked in a stationary and adjacent position with respect to the rear end 51 of the holder 11 owing to the rear corners C1, C2 that protrude through the rear slits 61, 62, while the front end 44 of the reservoir 4 is blocked in a stationary and adjacent position with respect to the front end 52 of the holder 11 owing to the front corners C3, C4 that protrude through the front slits 63, 64.

In reference to FIG. 9A, the rear corners C1, C2 and front corners C3, C4 are blocked in the slits 61, 62 and 63, 64, which can be narrower at one of their ends. This type of format makes it possible to insert the corners C1, C2, C3, C4 on the side of the wider end of the slits 61, 62, 63, 64 and to then block each of the corners C1, C2, C3, C4 at the narrowest end. In one preferred option with an inclined position of the reservoir 4 at least near the front end 44, this narrow end may be situated at the front, such that the effect of gravity naturally pushes the corners C1, C2, C3, C4 on the side of the narrowest end (by downward sliding). The gripping thus obtained at the corners C1, C2, C3, C4 makes it possible to keep the reservoir 4 in a stretched position that limits the formation of creases (little or no possibility of creasing during suction by the pump 5) and product retention, such that losses at the end of use of the reservoir 4 are significantly reduced.

FIG. 9A shows that the rear slits 61, 62 can be elongated in a first direction A1 that here is horizontal, while the front slits 63, 64 can be elongated in a second direction A2 different from the first direction A1. The front slits 63, 64 extend lower than the rear slits 61, 62 in the loaded configuration of the holder 11. It will be understood that the elongated shapes of the slits 61, 62, 63, 64 with a small play for the insertion of the corners C1, C2, C3, C4 make it possible to configure the reservoir 4 in a practically horizontal position, in this example with a gradual incline on the side of the front end 44.

In this example, the reservoir 4 has a parallelepiped format with four corners coming together at the rear C1, C2 and front C3, C4 corners. When the sheets 4a, 4b or similar walls of the reservoir 4 have an oblong format, the inner edge of the seam 4c or similar peripheral weld area may be rounded or curved toward the small sides, the outer edge of the seam 4c remaining rectangular such that each of the corners C1, C2, C3, C4 formed by that seam 4c has a generally triangular shape, as clearly shown in FIGS. 9A-9B. The corners C1, C2, C3, C4 here are engaged with the edge of the corresponding slits 61, 62, 63, 64. In one alternative embodiment, the holder 11 may have fastening members by gripping as a complement to or replacement for all or some of said slits 61, 62, 63, 64. Also alternatively, the peripheral weld seam 4c or any other marginal portion of the reservoir 4 may be engaged with removable fastening members at the rectilinear portions remote from the corners C1, C2, C3, C4. It is also allowable to provide a different arrangement of the fastening members or a number of fastening members smaller than four, for example by eliminating one of the rear slits 61, 62 and/or one of the front slits 63, 64 (with the understanding that it is also possible to provide a continuous slit over at least one of the panels 54a, 54b for the insertion of two corners C1 and C3 or C2 and C4 or other protruding projections of the reservoir 4).

The oblong or similarly elongated format of the rear slits 61 and 62, in a horizontal direction (when the holder 11 is engaged in the storage compartment 3), makes it possible to guide the reservoir 4 horizontally on the side of the rear end 43. The oblong or similarly elongated format of the front slits 63, 64, in an inclined direction substantially parallel to the slope defined by the bottom wall 53, makes it possible to downwardly incline part of the reservoir 4 close to the front end 44. Thus, even when little food product remains in the reservoir 4, for example less than 10% or 20% of the initial quantity, the general (practically horizontal) position of the reservoir 4 in the direction of the height remains the same, with the same length L and the same width, and above all with the same height level difference between the rear end 43 (raised using the rear slits 61, 62) and the front end 44 (still the same level using the front slits 63, 64). FIG. 7 illustrates the fact that the reservoir 4, at the end of use, may have a deformed appearance with the sheet 4a or similar wall having an outer face that has become concave, such that the final height of the reservoir 4 is reduced relative to its initial height H4.

However, due to the maintenance by the removable fastening members, the width and the length L may be unchanged or very slightly modified. It must also be noted that the slits 63, 64 are positioned at the same high level as the opening 4d of the reservoir 4, such that said opening 4d may be kept at its height level independently of the variations in the inner volume of the reservoir 4 during food product extraction operations.

One of the advantages of an apparatus 1 lies in the effective control of the preservation and dispensing of a food product such as yogurt, for which many requirements exist and which is typically difficult to make flow due to its viscosity. Furthermore, the apparatus 1 may have a compact and practical arrangement for replacement operations for the consumable assembly W, due to the spatial distribution of that assembly (just behind the door 8). As an example, the ratio between the volume of food product contained in the reservoir 4 before the distribution and the upper volume defined by the chassis 2 above the passage 30 may be comprised between 1:10 and 1:5. With a collection compartment CC with a height smaller than or equal to about 20 cm (for example about 15 cm), the outer volume of the apparatus 1 may represent at most 12 times the volume of the food product. The height H of the apparatus 1 may be smaller than 60 cm (for example about 55 cm) and the storage compartment 3 suitable for receiving a reservoir 4 containing 5 kg of food product. The apparatus 1 is therefore particularly easy to install in all locations and is user-friendly, while also respecting the strict requirements for hygienic preservation.

It will be understood that each of the examples and each of the embodiment details previously described may be used alone (for example, the operation of the pump 5 of the extraction device 20 on the one hand and the cooperation between the reservoir 4 and the holder 11 on the other hand) or in combination. It must thus be obvious for those skilled in the art that the present invention allows embodiments in many other specific forms without going beyond the scope of application of the invention as claimed.

1. An apparatus for preserving and dispensing, on demand, a liquid or pasty food product, comprising:
a storage compartment;
a reservoir comprising an opening, the reservoir having a length defining a larger dimension of the reservoir, the reservoir extending lengthwise between a rear end and a front end near which the opening is positioned, the reservoir containing food product;
a dispensing line connected to the reservoir at the opening to channel the food product;
a holder for mounting the reservoir inside the storage compartment;
an extraction device for the food product channeled in the dispensing line; and
a cooling device suitable for refrigerating the food product contained in the reservoir when the reservoir is in the storage compartment;
wherein the reservoir is a malleable packaging configured to deform in response to the extraction of the food product outside the reservoir, the holder having a rear end, a front end and an upper opening extending between the front end and the rear end of the holder, the holder further comprising:
a slit configured to be passed through by the dispensing line in a loaded configuration of the holder in which the reservoir is mounted on the holder; and
at least one first fastening member to keep, in the loaded configuration of the holder, the rear end of the reservoir in a stationary and adjacent position with respect to the rear end of the holder; and
at least one second fastening member to keep, in the loaded configuration of the holder, the front end of the reservoir in a stationary and adjacent position with respect to the front end of the holder.

2. The apparatus according to claim 1, wherein the at least one first fastening member is provided with two first fastening members and the at least one second fastening member is provided with two second fastening members, and wherein said first and second fastening members are configured to attach the reservoir to the holder removably, the holder including two panels, a bottom wall connecting the two panels, each of the panels including:
one of the two first fastening members adjacent to the rear end of the holder; and
one of the two second fastening members, adjacent to the front end of the holder.

3. The apparatus according to claim 1, wherein the rear end of the holder is raised with respect to the front end when the holder is in the loaded configuration inside the storage compartment, the bottom wall extending inclined downwardly from the raised rear end of the holder as far as the front end of the holder.

4. The apparatus according to claim 1, wherein the reservoir is made by assembling two sheets made from a flexible material each having an oblong shape and welded to each other by a peripheral weld seam, the reservoir having a height defining a smaller dimension of the reservoir and measured transversely with respect to the peripheral weld seam.

5. The apparatus according to claim 2, wherein the reservoir is made by assembling two sheets made from a flexible material and welded to each other by a peripheral weld seam, the peripheral weld seam having four sides coming together forming two rear corners on the side of the rear end of the reservoir and two front corners on the side of the front end of the reservoir, the front corners each protruding outward and being engaged with the first fastening members and the rear corners each protruding outward and being engaged with the second fastening members.

6. The apparatus according to claim 2, wherein the dispensing line extends continuously downward from a first height level defined by the opening of the reservoir as far as an outlet, the second fastening members being configured at a same second height level that coincides with said first height level, whereby said opening can be kept at the first height level despite the decrease in the inner volume of the reservoir during food product extraction operations.

7. The apparatus according to claim 2, wherein the first fastening members comprise two first slits distributed in each of the two panels and elongated in a first direction, while the second fastening members comprise two second slits distributed in each of the two panels and elongated in a second direction, the first direction being different from the second direction.

8. The apparatus according to claim 7, wherein the first direction is horizontal and the two second slits extend lower than the two first slits when the holder is in a loaded configuration inside the storage compartment.

9. The apparatus according to claim 1, wherein the extraction device comprises a peristaltic pump, the dispensing line having a flexible hose designed to cooperate with the pump, said pump being configured to circulate the food product toward an outlet in response to a command to dispense a dose of food product.

10. The apparatus according to claim 9, wherein the reservoir and the pump are arranged in a same enclosure including the storage compartment and refrigerated by the cooling device, the storage compartment being deeper than tall.

11. The apparatus according to claim 1, wherein the holder comprises two panels and a bottom wall connecting the two panels, the slit extending between the two panels and below any one of the first fastening member and the second fastening member.

12. The apparatus according to claim 11, wherein the malleable packaging is a flexible pouch and said opening, which is a single opening of the flexible pouch, is facing the bottom wall.
